(19) United States
(12) Patent Application Publication
(10) Pub. No.: US 2006/0216676 A1
(43) Pub. Date: Sep. 28, 2006

(54) Educational apparatus for children

(76) Inventors: James L. Coffey, Christiansted, VI (US); Judith J. Coffey, Christiansted, VI (US)

Correspondence Address: GOTTLIEB RACKMAN & REISMAN PC, 270 MADISON AVENUE, 8TH FLOOR, NEW YORK, NY, 100160601, US

(21) Appl. No.: 11/372,662

(22) Filed: Mar. 10, 2006

Related U.S. Application Data
(60) Provisional application No. 60/660,378, filed on Mar. 10, 2005.

(51) Int. Cl. G09B 19/00

(52) U.S. Cl. 434/156

(57) ABSTRACT

An educational apparatus for children consisting of a rigid board that displays graphical and/or textual images is provided. A portion of the image is concealed by movable sections, such as flaps or sliding sections, and can be revealed by moving these sections. The concealed portion of the image may be on interchangeable cards.

### RELATED APPLICATIONS

This application claims priority to U.S. provisional application Ser. No. 60/660,378 filed Mar. 10, 2005 and incorporated herein by reference.

### BACKGROUND OF THE INVENTION

A. Field of the Invention

This invention presents an educational apparatus for graphically and/or textually displaying stories, graphs, problems, solutions and other educational information to children.

B. Description of the Prior Art

Children's books with multiple pages and with revealing means are known in the art. These devices typically have text or images and movable parts that reveal additional information or create a three-dimensional structure, such as a pop-out, when used. Some of these devices emit predetermined sounds when activated.

However, the existing devices are collections of pages or books that contain words and flip-ups on the same page, requiring that teachers or parents hold the book in a position that enables both the teacher to read the words and children to see the flip-up, and also requiring the teacher to be able to operate the flip-up at the same time. This process is difficult and cumbersome, essentially requiring two hands to hold the book and one to operate the flip-up. Also, the teacher or parent must hold the book in front of him or her, facing the children, and move his or her head around to be able to read the story. No device exists that employs a single rigid board with flip-ups and/or interchangeable insert cards allowing an adult teacher or parent to teach children logic, association, pattern recognition, outcome prediction, sequencing events, drawing conclusions, and making generalizations. Furthermore, the existing art does not envision a solution to the difficulties of holding a book open, reading aloud, turning pages, and opening flip-ups at the same time. Also, the prior art does not address the importance of teachers facing children, so that the children can see the teacher's mouth and expression as he or she reads the words.

What is needed, therefore, is a simple educational device of a convenient size to children that can be used by teachers in an educational setting with a single child or multiple children and can be read and operated easily with two hands and with the teacher facing the children at all times.

### SUMMARY OF THE INVENTION

This invention meets the current need for a simple educational apparatus for children that can be read and operated easily. A novel educational apparatus for graphically and/or textually displaying stories, graphs, problems, solutions and other information to children in a classroom or other educational setting is provided. The apparatus is typically composed of a rigid board with flaps. The image placed on the front of the board runs on the flaps as well, but when the flaps are flipped, another image or a place for an interchangeable card with another image is revealed. Text may be placed on the back of the board so that the teacher may read the story or lesson while showing children the image on the front of the board. As the teacher holds the educational apparatus in front of him or her and reads the words on the back of the board, facing the children at all times, the teacher can operate the flap on the front of the board as the children view the picture. Thus, at all times, children are seeing the teacher's face and the picture on the front of the board, including the flap or flaps.

The purpose of the apparatus is to support and enhance the learning process in various ways that are consistent with well-established learning theory, as enumerated below. The apparatus permits unsupervised use by individual children or small groups of children as desired. However, the device is intended primarily to be used by a teacher or parent in the presence of a group of children. Furthermore, the apparatus may be utilized outside of a typical classroom setting for play, parenting and educational purposes or simply to keep children engaged during their free time.

Significantly, the apparatus allows graphical and/or textual information to be alternately concealed and revealed at appropriate times and further allows the concealed graphical and/or textual images to be changed as desired by the child user or another individual.

Furthermore, the apparatus may incorporate a mounting means so that a parent or teacher can use both hands while teaching a group of children while the apparatus is vertically suspended. The mounting means may include a post attachment, a hook or an aperture for hanging the apparatus, or a Velcro attachment that would allow the apparatus to stick to objects or vertical surfaces with a reciprocal Velcro attachment.

Overall, the apparatus functions as an educational tool that motivates children to employ thinking and reasoning skills in order to accurately reach the answer or solution to a problem that lies behind the flap. The apparatus also promotes and stimulates logical reasoning and thinking in children as they practice various association skills, including “cause and effect,” prediction of probable outcomes, sequencing events, drawing conclusions, making generalizations, and so on. The sequence of the boards utilized in any given story is systematically programmed to ensure correct predictions, associations and memorable learning. By providing immediate feedback to children, the apparatus reinforces correct reasoning in children and instantly corrects faulty reasoning.

The apparatus further provides a vehicle for children to interact with one another as they work independently and/or in pairs to create new stories, re-tell stories, predict endings, and so on. The device may be employed for purposes of sequencing story events, changing known story events and outcomes, and creating and telling new stories. For such uses, multiple movable sections, such as flaps, panels and windows, or combinations thereof, may be incorporated into the device. Because each story is told with multiple rigid boards, children are able to spread the boards out on a surface and rearrange them or remove one or more boards to change the sequence of the events in the story. This is not possible with a book.

Moreover, the device utilizes the important element of surprise and a child's natural curiosity as a tool to help the child actually want to learn. It also encourages children to assess their own work and motivates them to try again when wrong to ultimately achieve success.

The apparatus may also be modified as needed to assess and document various literacy, mathematical, and scientific skills, as well as skills in other fields of learning. Accordingly, when in the context of assessing a child's mathematical skills, answers to solutions or variables in equations may be covered for a period of time as desired.

It is, therefore, an object of the present invention to provide a simple, easy-to-use educational apparatus for children that can be used by teachers and parents with individual children or groups of children.

Another object of the present invention is to support and enhance the learning process of children.

A further object of the present invention is to use the invention as an educational tool that motivates children to employ critical thinking and reasoning skills.

Yet another object of the present invention is to provide a vehicle for children to interact with one another.

Still other objects of the present invention will be obvious from the following description.

### BRIEF DESCRIPTION OF THE DRAWINGS

FIG. 1 is a top view of the educational apparatus of the present invention;

FIG. 2 is a perspective view of the educational apparatus of the present invention showing the use of the educational apparatus;

FIG. 3 is a front overhead view of the educational apparatus of FIG. 2 showing the use of the educational apparatus;

FIG. 4 is a top view of the educational apparatus of FIG. 2 with the flap closed;

FIG. 5 is a top view of the educational apparatus of FIG. 2 showing the use of the educational apparatus;

FIG. 6 is a top view of the educational apparatus of FIG. 2 showing the use of the educational apparatus;

FIG. 7 is a top view of a different embodiment of the educational apparatus of the present invention showing the use of the educational apparatus;

FIG. 8 is a top view of the embodiment of the educational apparatus of FIG. 7 showing the use of the educational apparatus; and

FIG. 9 is a top view of the embodiment of the educational apparatus of FIG. 7 showing the use of the educational apparatus.

### DETAILED DESCRIPTION OF THE PREFERRED EMBODIMENTS

With respect to its configuration, the apparatus preferably comprises a rigid board of appropriate size to be displayed to a classroom of children upon which printed artwork, photographs, text and/or other images can be located. In an alternative embodiment, the rigid board may also be a folding board. The board is preferably made of cardboard, plastic, or another suitable material that is safe for children.

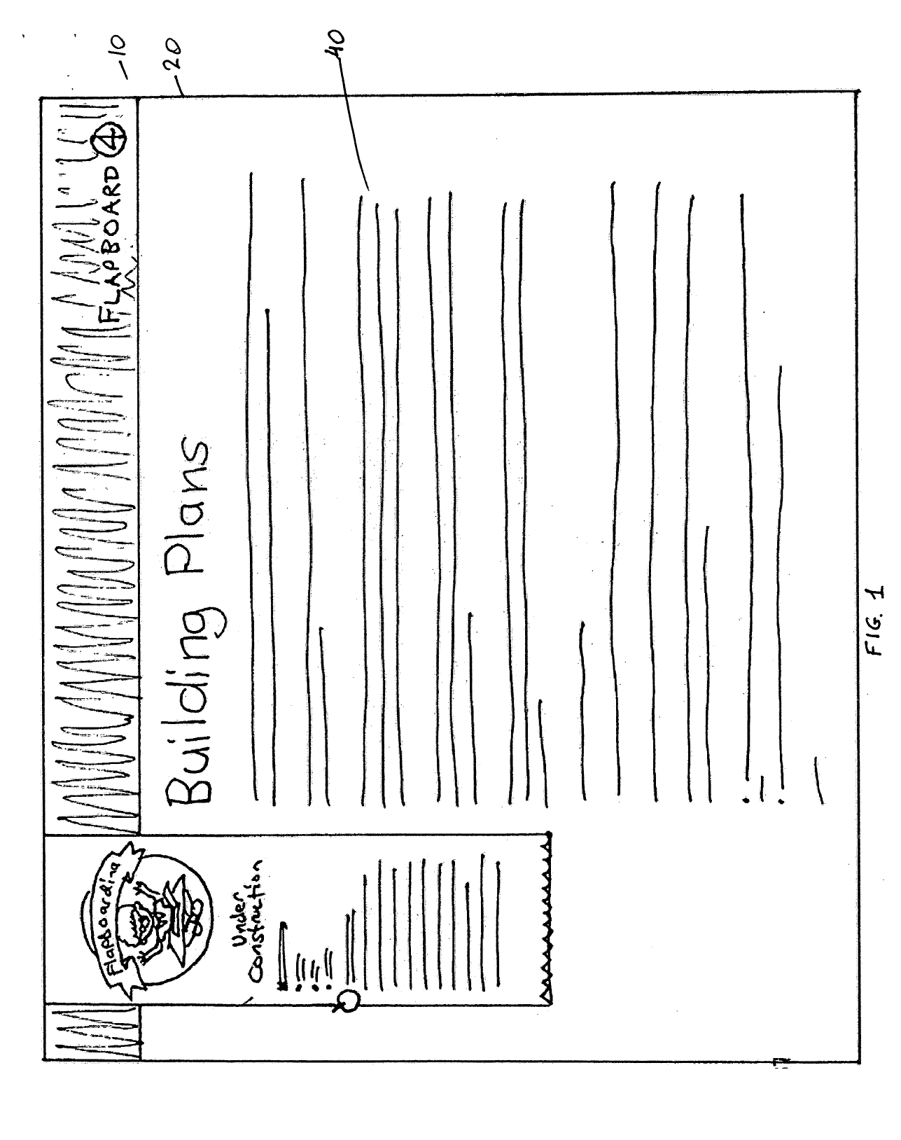

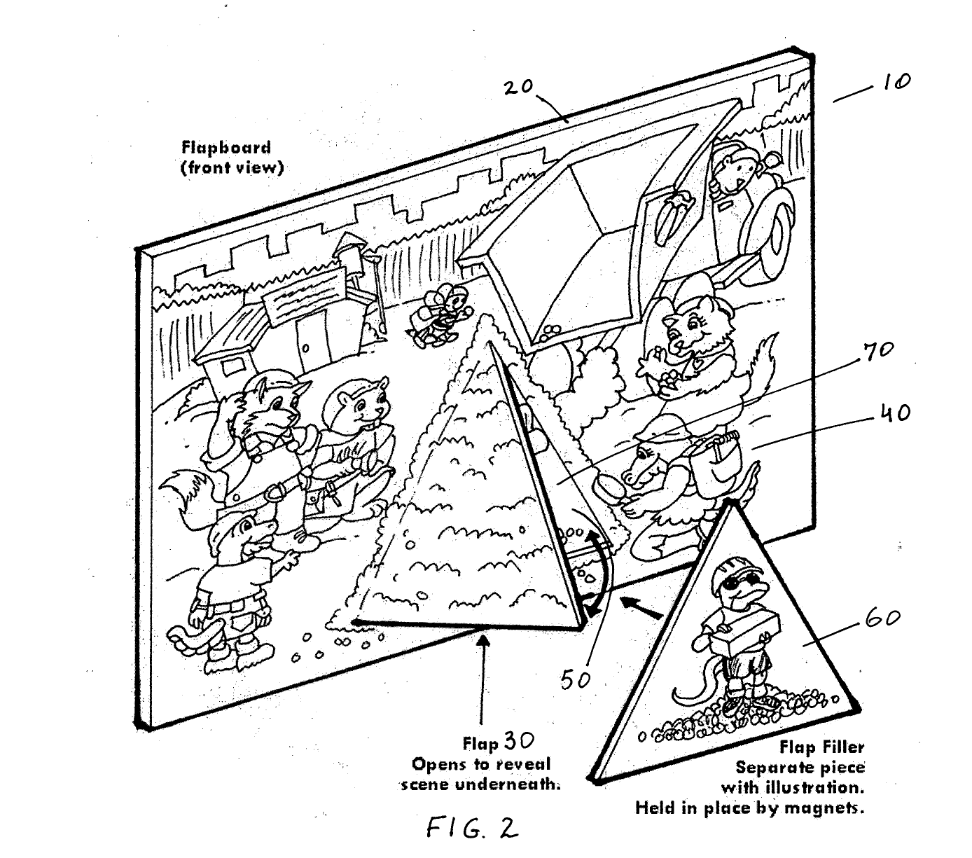

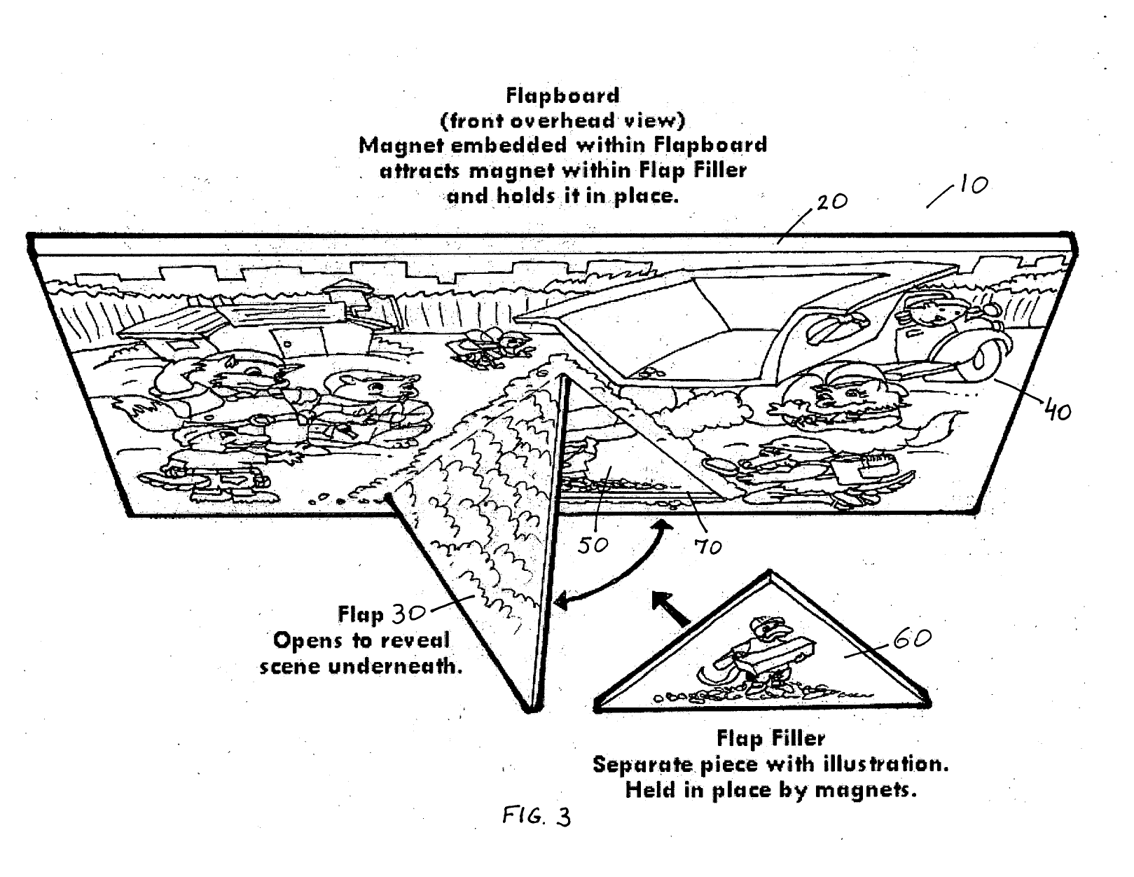

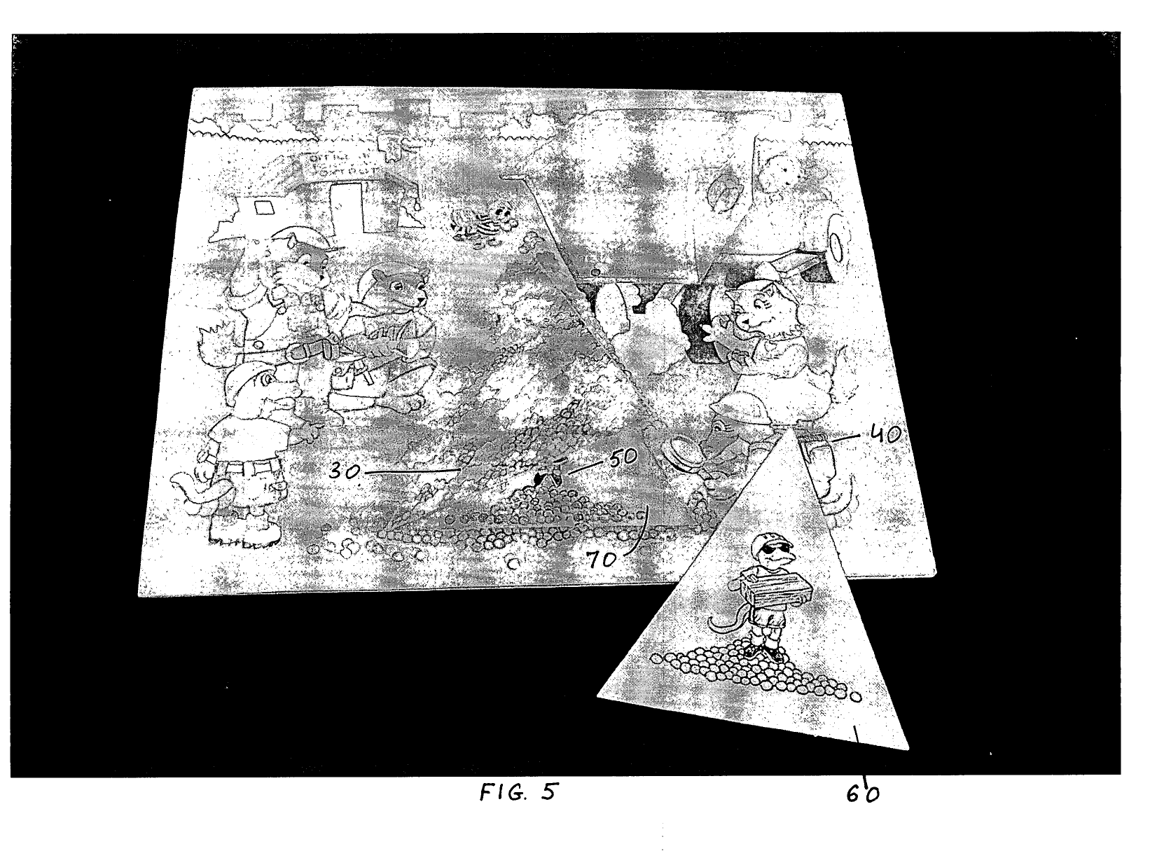

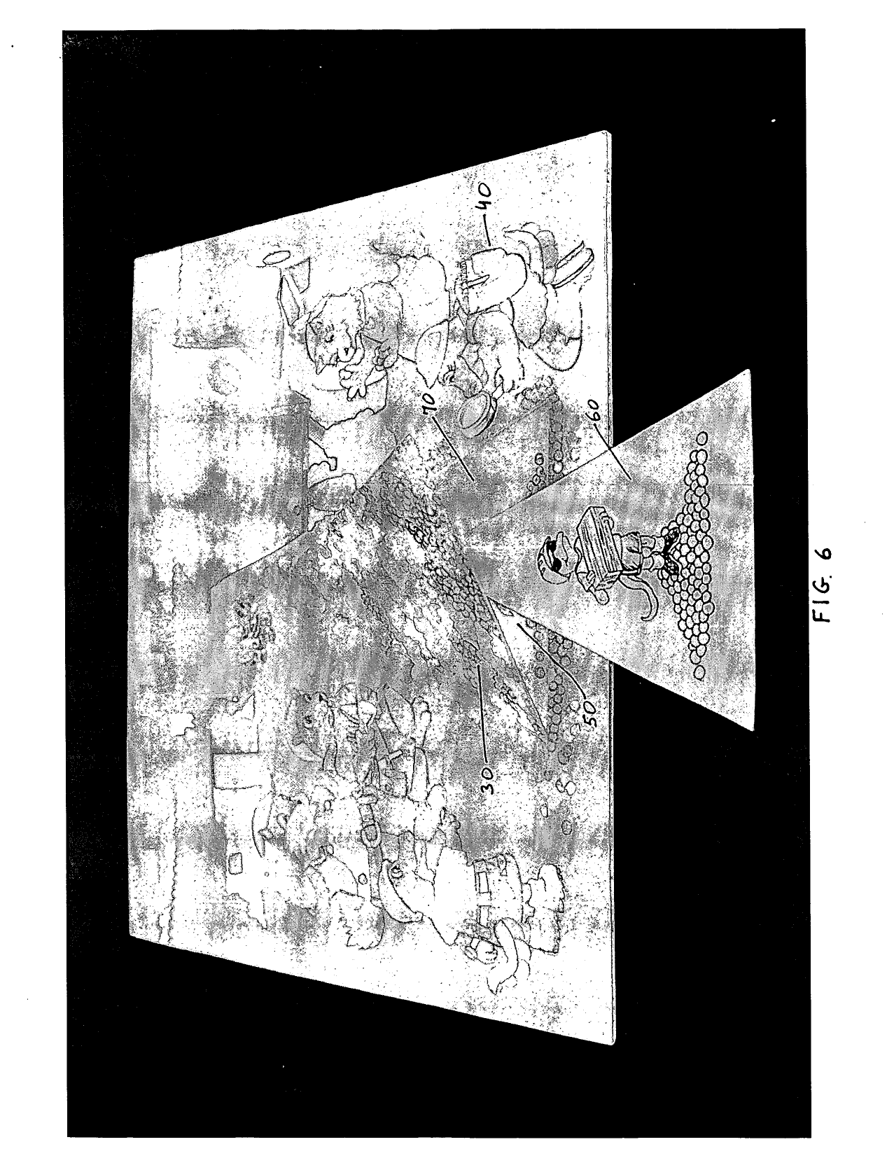

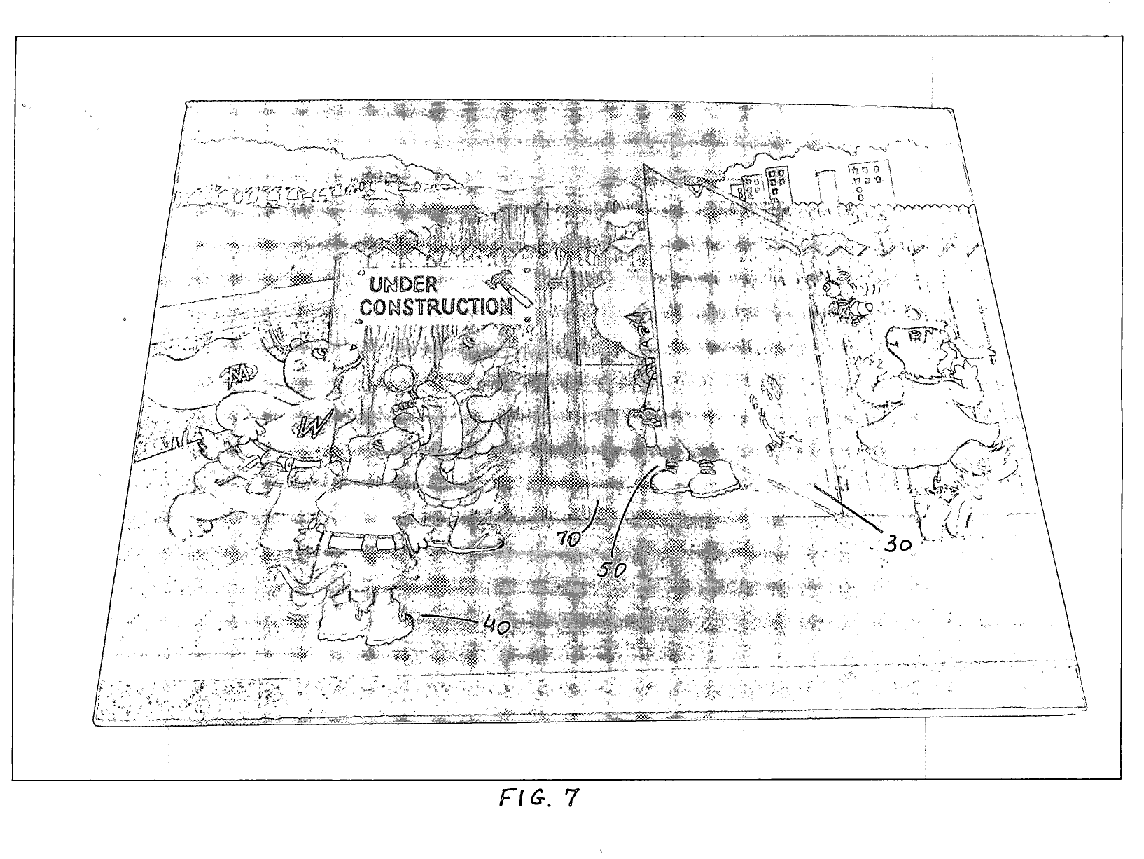

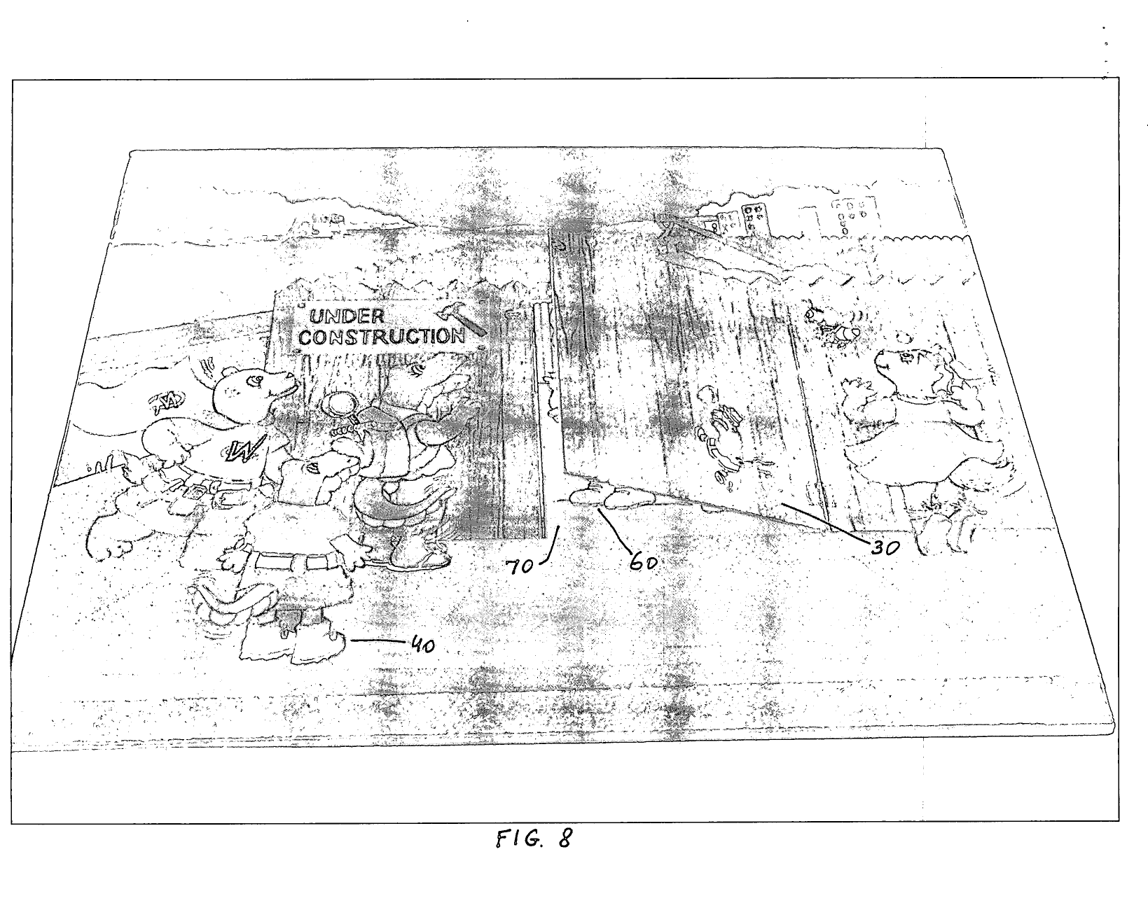

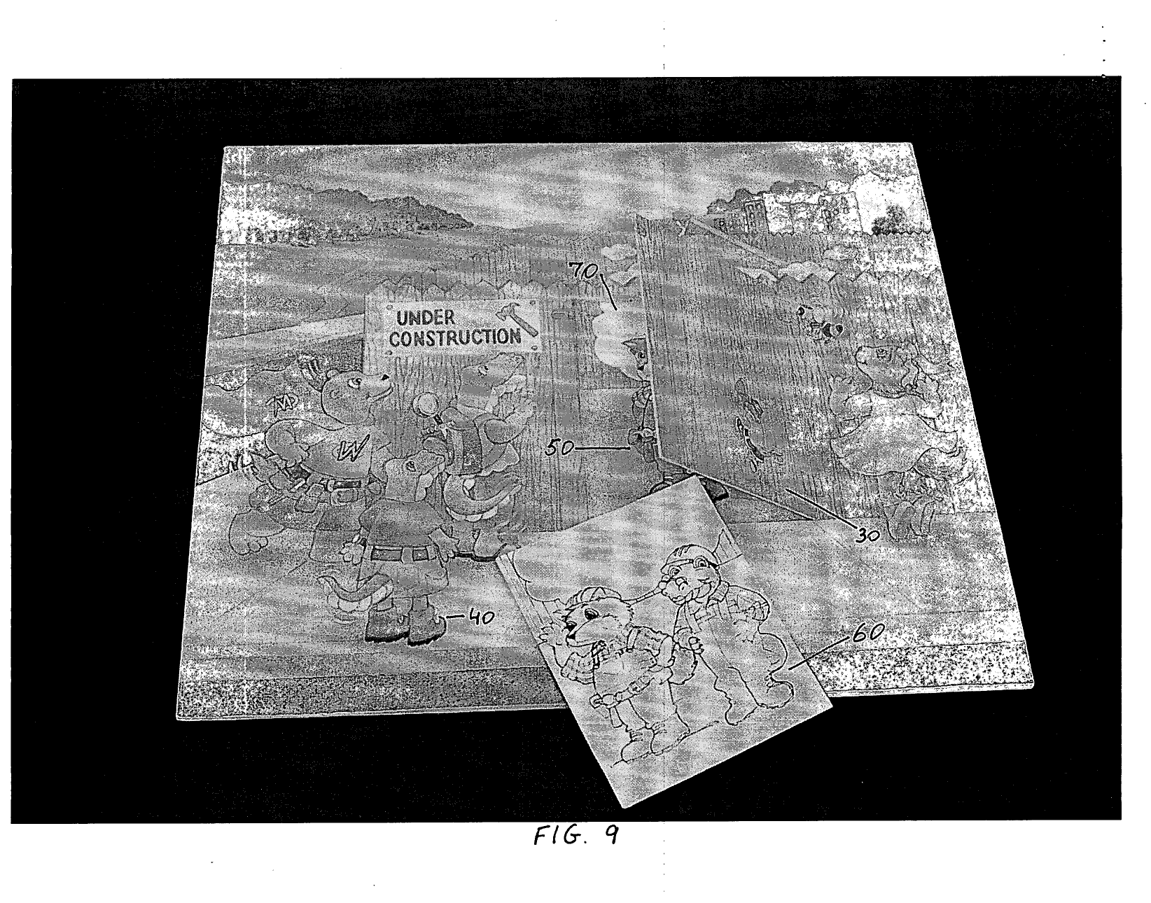

With reference to FIG. 1 through FIG. 9, the apparatus 10 has an element 20, which is preferably a rigid board. The element 20 has at least one movable section 30 (such as a flap shown in FIG. 2 and FIG. 3) that can have various geometric configurations or shapes. The element 20 displays a primary graphical and/or textual image, and the movable section 30 displays a secondary graphical and/or textual image, where the primary and secondary images define the overall graphical and/or textual presentation 40 of the element 20. The movable section 30 is preferably hinged to the element 20 and is capable of being folded back to reveal an additional image 50, a blank space for erasable markers, or a card 60 underneath. The card 60 is preferably retained in a recess 70 in the element 20.

In an alternative embodiment, the element 20 does not include a recess 70, and the movable section 30 simply covers a portion of the element 20. In this embodiment, the card 60 may be attached directly to the covered portion of the element 20. The card 60 is interchangeable, and a number of such cards may be employed with the educational apparatus 10. Allowing a concealed, changeable image on the card 60 is an important feature of the present invention because it helps teach children outcome prediction, sequencing events, drawing conclusions, and making generalizations.

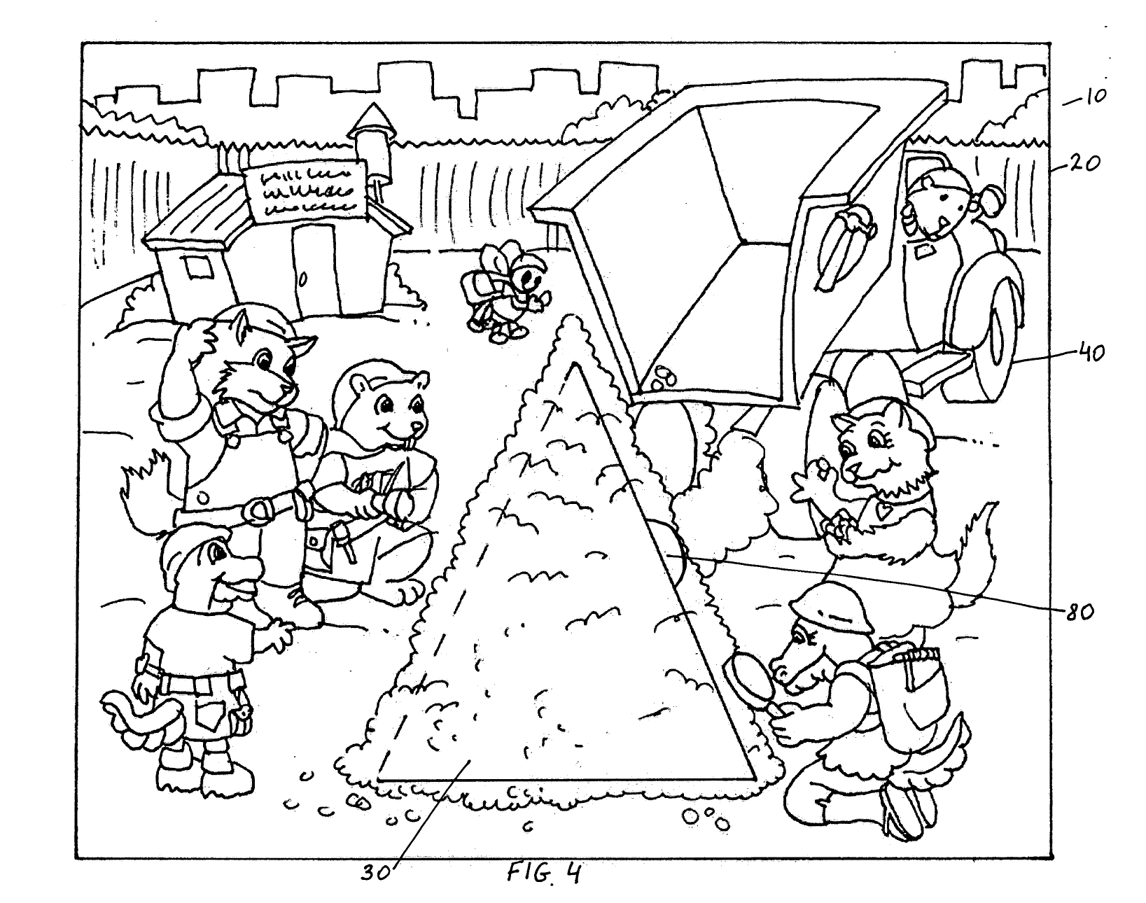

As illustrated in FIG. 4, the element 20 may further include a notch 80 or a tab adjacent to the recess 70, the notch 80 being capable of accepting a finger or a fingernail (the tab would be capable of being grasped by fingers) to assist the user in lifting the flap (i.e., the movable section 30).

Furthermore, the shape of the movable section 30 and the recess 70 thereunder can be associated with a particular type of image that should be situated beneath the movable section 30 (i.e., within the recess 70). Accordingly, squares can be associated with images of people, round inserts can be associated with objects, triangles with numbers, etc. Thus, by matching the shape of the card 60 to the shape of the recess 70, children can be assured of appropriately filling the recess 70 with an appropriate card 60 for the story or lesson being taught. This association also aids in the recognition of various shapes.

Significantly, the card 60 underneath the movable section 30 is removable and can be replaced with different image cards as required for purposes of changing the outcome of a problem, story or other educational “event.” In any embodiment, the image cards 60 may be held in place beneath the movable section 30 by magnets, hook and loop means such as Velcro, felt, slick plastic surfaces, or other appropriate adhering mechanisms that allow selective attachment and removal of the image cards. Alternatively, in the embodiment of the educational apparatus with a recess 70, the card 60 may be placed into the recess 70 and covered with and held in place by the movable section 30.

In an alternative embodiment, the movable section 30 of the element 20 may be a sliding panel, which can be raised or otherwise slid aside to reveal the second image 50 or card 60. In another embodiment, instead of utilizing an image card with a single image thereon, the apparatus comprises a rotating disk device on which various images are located and which may rotate consecutively into a window or open space on the main board.

In addition, the element 20 may contain a blank area to allow children to modify the story or lesson as they envision on their own or to contrast the image under the movable section 30 or on the element 20 itself. In such areas, the element 20 may comprise a surface for employing erasable markers or other removable display materials. The blank area may also be included in the recess 70.

Although the invention has been described in terms of particular embodiments, the embodiments are merely illustrative of an application of the principles of the invention. Numerous modifications may be made and other arrangements may be devised without departing from the spirit and scope of the invention.

It is thus seen that the objects set forth above are achieved by the invention described herein. The scope of the invention is now found in the following claims.

What is claimed is:

1. An educational apparatus for displaying information to children, comprising:
an element displaying a primary graphical and/or textual image; and
at least one movable section displaying a secondary graphical and/or textual image and selectively covering a portion of said element, said movable section being selectively movable between an open position wherein the portion of said element is exposed and a closed position wherein the portion of said element is concealed;
wherein the primary graphical and/or textual image of said element and the secondary graphical and/or textual image of said at least one movable section together define a single graphical and/or textual presentation.

2. The educational apparatus of claim 1, wherein said element is a rigid board.

3. The educational apparatus of claim 1, wherein said at least one movable section is a flap.

4. The educational apparatus of claim 3, wherein said flap is hinged to said element.

5. The educational apparatus of claim 1, wherein said at least one movable section is slidably movable along a surface of said element.

6. The educational apparatus of claim 1, wherein said element includes a window and said at least one movable section rotates selectively to display the secondary graphical and/or textual image in said window.

7. The educational apparatus of claim 1, further comprising a coupling for attaching said educational apparatus to an object.

8. The educational apparatus of claim 1, wherein said portion of said element displays an additional graphical and/or textual image.

9. The educational apparatus of claim 8, wherein the geometric shape of said at least one movable section is associated with said additional graphical and textual image displayed on said portion of said element.

10. The educational apparatus of claim 1, wherein said portion of said element includes a surface for erasably marking said portion of said element.

11. The educational apparatus of claim 1, further comprising at least one card member removably mountable onto said portion of said element.

12. The educational apparatus of claim 11, wherein the at least one card member displays a further graphical and/or textual image.

13. An educational apparatus for displaying information to children, comprising:
an element displaying a primary graphical and/or textual image and having at least one recess and at least one movable section displaying a secondary graphical and/or textual image, said at least one movable section being selectively movable between an open position wherein the recess is exposed and a closed position wherein the recess is concealed;
wherein the primary graphical and/or textual image of said element and the secondary graphical and/or textual image of said at least one movable section together define a single graphical and/or textual presentation.

14. The educational apparatus of claim 13, wherein said element is a rigid board.

15. The educational apparatus of claim 13, wherein said at least one movable section is a flap.

16. The educational apparatus of claim 15, wherein said flap is hinged to said element.

17. The educational apparatus of claim 13, wherein said at least one movable section is slidably movable along a surface of said element.

18. The educational apparatus of claim 13, wherein said element includes a window and said at least one movable section rotates selectively to display the secondary graphical and/or textual image in said window.

19. The educational apparatus of claim 13, further comprising a coupling for attaching said educational apparatus to an object.

20. The educational apparatus of claim 13, wherein said recess of said element displays an additional graphical and/or textual image.

21. The educational apparatus of claim 20, wherein the geometric shape of said at least one movable section is associated with said additional graphical and/or textual image displayed in the recess of said element.

22. The educational apparatus of claim 13, wherein the recess of said element includes a surface for erasably marking the recess of said element.

23. The educational apparatus of claim 13, further comprising at least one replaceable card member selectively mounted along said recess of said element.

24. The educational apparatus of claim 23, wherein the at least one replaceable card member displays a further graphical and/or textual image.

25. The educational apparatus of claim 13, wherein said at least one movable section is received within said recess.

26. The educational apparatus of claim 25, wherein the geometric configurations of said at least one movable section and said recess are substantially the same.
